(19) United States
(12) Patent Application Publication
(10) Pub. No.: US 2007/0005607 A1
(43) Pub. Date: Jan. 4, 2007

(54) Interface control program, interface control method, interface control apparatus, plug-in program and information processing apparatus

(75) Inventors: Shigeki Fukuta, Kawasaki (JP); Takao Mohri, Kawasaki (JP); Satoru Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/287,199

(22) Filed: Nov. 28, 2005

(30) Foreign Application Priority Data
Jun. 29, 2005 (JP) 2005-189303

(51) Int. Cl. G06F 17/30

(52) U.S. Cl. 707/10

(57) ABSTRACT

The present invention provides a signal for carrying an interface control program for making a first information processing apparatus let a specific program carry out a processing in response to an operation request from a second information processing apparatus and carry out a processing of transmitting the processed information to the second information processing apparatus when the first information processing apparatus is executing the aforementioned specific program, wherein the interface control program makes the first information processing apparatus carry out the first process for obtaining information about an operation screen of the specific program being executed by the first information processing apparatus and recognizing display elements contained by the information; and the second process for generating screen information on the first information processing apparatus by either the display elements or a combination thereof in response to the operation request from the second information processing apparatus and transmitting the generated screen information thereto.

### BACKGROUND OF THE INVENTION

1. Field of the Invention

The present invention relates to a technique for operating an operation screen of an information processing apparatus remotely from another information processing apparatus, and in particular to a technique for operating an operation screen of information processing apparatus remotely from an information terminal with a limited input and output equipment only, such as a cellular phone.

2. Description of the Related Art

In recent years, so called GUI (graphical user interface) has been in the mainstream of operating method for a computer in either basic software such as operating system or application program (simply “application” hereinafter).

That is, in the operation of operating system, displaying a basic operation screen so called “desktop” in the computer screen, and operating an icon (i.e., pictographic character) placed on the desktop with a pointing device such as a mouse, thereby operating various operations such as starting various programs and handling a file relevant to the icon.

And, in the operation of an application, displaying a window with a variable display position and size on the computer screen, and the user operating various display elements placed on the window, thereby issuing various instructions to the application.

Meanwhile, with the growth in information networks and mobile terminals such as cellular phones, a so called remote operation technique, for operating a stationary information processing apparatus such as a personal computer (PC) and server remotely from a mobile terminal, has been increasingly popular.

A conventional remote desktop operation technique such as VNC (virtual network computing) or Remote Desktop only cuts out a remote desktop screen to output to a mobile terminal screen and merely has input assist functions limited to a key conversion and mouse emulation in terms of operation interface. Because of this, the operation is only limited to using an operation system of the desktop developed specifically for the hardware environment of stationary information processing apparatus made up of a mouse, keyboard and wide display screen and therefore it has usually been difficult to operate from a mobile terminal with a severe constraint in terms of information display means or information input means.

For example, an application on the desktop is operated by pressing an iconized button or pointing an object with a mouse. However, because it is difficult to press a button or point at an object placed graphically effectively in a mobile terminal having no mouse, it has been difficult to operate such an application.

In addition, a narrow screen of a mobile terminal has no space for displaying a tool bar and/or hierarchically shown sub-panels continuously, making all the more important to display focused information by enlarging to a maximum.

That is, the required operating environment is to maintain an operation content of a standard desktop while a display screen form and operation are customized to the mobile terminal.

As a conventional example, the patent document 1 utilizes a remote desktop operating technique such as the VNC and takes advantage of input & output plug-in module, thereby performing an enlargement and reduction of bit map image on the desktop screen and an input conversion such as a conversion from a disparate interface to mouse event, et cetera.

Applications actually used, however, require respectively different optimum settings and/or screen sizes, individually unique operation methods, and consequently a common input conversion method such as a conversion to a simple mouse event has made it difficult for a mobile terminal with a limited number of input buttons to carry out an operation adequately. For example, it has been necessary to let a user perform cumbersome operations such as pressing a mouse emulation button utilizing a cursor key and scroll operation in a focus area.

As another conventional technique, the patent document 2 has disclosed a technique for an attempt to accomplish a remote operation of software resident on the remote side over from a local side by correlating an object, which is a software component, between a local host and remote host. The technique put forth by the patent document 2, however, premises an installation of common software platform in both the local and remote hosts, and requires an installation of object in the application per se in consideration of a remote operation, bringing about a concern over its versatility.

And the patent document 3 has disclosed a technique to furnish a server computer connected by information terminals with a security unit for managing a security associated with a connection, disconnection and resumption of line and an applied function conversion unit for converting data such as an application program residing in the server computer to information usable by a user based on attribute information about the current user of the information terminal. The applied function conversion unit, however, is for converting a data format such as a document data handled by an application program, and does not disclose any recognition with regard to a technical problem such as an operating interface for an application program in response to a hardware environment of information terminal.
[Patent document 1] Japanese patent laid-open application publication No. 2003-208402
[Patent document 2] Japanese patent laid-open application publication No. 2002-41309
[Patent document 3] Japanese patent laid-open application publication No. 11-122262

### SUMMARY OF THE INVENTION

A purpose of the present invention is to provide a remote desktop operation technique capable of accomplishing a remote desktop operation environment matching with a capability of an information terminal such as a mobile terminal in terms of screen display form and operation while maintaining an operation content of a standard desktop.

Another purpose of the present invention is to provide a remote desktop operation technique capable of optimizing diverse operation interfaces for operating systems and individual applications according to a capability of information terminal in the remote desktop operation.

A first aspect of the present invention provides a signal for carrying an interface control program that makes a first information processing apparatus let a specific program carry out a processing in response to an operation request from a second information processing apparatus and carry out a processing of transmitting the processed information to the second information processing apparatus when the first information processing apparatus is executing the aforementioned specific program, in which

the interface control program makes the first information processing apparatus carry out

the first process for obtaining information about an operation screen of the specific program which is executed by the first information processing apparatus and recognizing display elements which are contained by the information; and

the second process for generating screen information on the first information processing apparatus by either the display elements or a combination of the display elements in response to the operation request from the second information processing apparatus and transmitting the generated screen information to the second information processing apparatus.

A second aspect of the present invention provides an interface control method for a first information processing apparatus which lets a specific program carry out a processing in response to an operation request from a second information processing apparatus and which carries out a process of transmitting the processed information to the second information processing apparatus when the first information processing apparatus is executing the aforementioned specific program, in which

the first information processing apparatus carries out

the first process for obtaining information about an operation screen of the specific program which is executed by the first information processing apparatus and for recognizing display elements which are contained by the operation screen information; and

the second process for generating screen information on the first information processing apparatus by either the display elements or a combination of the display elements in response to the operation request from the second information processing apparatus and transmitting the generated screen information to the second information processing apparatus.

A third aspect of the present invention provides an interface control apparatus that makes a specific program carry out a processing in response to an operation based on an operation request from a second information processing apparatus when executing the specific program and that carries out a processing of transmitting the processing information to the second information processing apparatus, which comprises:

first unit for obtaining information about a operation screen of the specific program and recognizing display elements which are contained by the information; and

second unit for generating screen information on the first unit by either the display elements or a combination of the display elements in response to the operation request from the second information processing apparatus and transmitting the generated screen information to the second information processing apparatus.

A fourth aspect of the present invention provides a signal for carrying a plug-in program that makes a first information processing apparatus carry out a process of adding a function to an application program which is executed by a first information processing apparatus, in which

the plug-in program makes the first information processing apparatus carry out the processes of

recognizing display elements of operation screen for the application program;

registering the display elements in a program list in order to select the application program, and

preparing an auxiliary application program interface (aux. API) in order to change a display form of the display elements on a second information processing apparatus which operates the application program remotely.

A fifth aspect of the present invention provides an information processing apparatus that carries out an application program, comprising a control logic which comprises:

a first function which recognizes display elements of operation screen of the application program; and a second function which responds to a display request from another information terminal by the display elements or a combination of the display elements.

According to the above described present invention, it is possible to recognize an operation screen of program, et cetera, running in the first information processing apparatus by a unit of constituting elements, present each constituting element and/or a combination of some constituting elements to the second information processing apparatus operating the program remotely, and accordingly change a display form of the constituting elements on the aforementioned second information processing apparatus if required.

This makes it possible to customize a display of operation screen and an operation input method which are suitable to the characteristic of not only a hardware configuration of the second information processing apparatus as operation terminal, but also each application program. This also enables a setup of application and automatic change of state easily, which have been difficult according to the conventional technique.

### BRIEF DESCRIPTION OF THE DRAWINGS

FIG. 1 is a conceptual diagram exemplifying a remote desktop operation method according to an embodiment of the present invention;

FIG. 2 is a conceptual diagram exemplifying a comprisal of information processing system for carrying out a remote desktop operation method according to an embodiment of the present invention;

FIG. 3 is a conceptual diagram exemplifying a comprisal of server apparatus for carrying out a remote desktop operation method according to an embodiment of the present invention;

FIG. 4 is a conceptual diagram exemplifying a comprisal of information terminal apparatus for carrying out a remote desktop operation method according to an embodiment of the present invention;

FIG. 5 is a plain view exemplifying an external view of information terminal apparatus according to an embodiment of the present invention;

FIG. 6A describes a setup example of terminal profile used in a remote desktop operation method according to an embodiment of the present invention;

FIG. 6B describes a setup example of terminal profile used in a remote desktop operation method according to an embodiment of the present invention;

FIG. 6C describes a setup example of terminal profile used in a remote desktop operation method according to an embodiment of the present invention;

FIG. 7 describes an example of basic operation screen used in a remote desktop operation method according to an embodiment of the present invention;

FIG. 8 is a conceptual diagram showing an example comprisal of operation screen for an application used in a remote desktop operation method according to an embodiment of the present invention;

FIG. 9 is a block diagram exemplifying a functional comprisal of plug-in used in a remote desktop operation method according to an embodiment of the present invention;

FIG. 10 is a conceptual diagram showing an example comprisal of application profile used in a remote desktop operation method according to an embodiment of the present invention;

FIG. 11 is a flow chart exemplifying an operation of plug-in at startup of an application for a remote desktop operation method according to an embodiment of the present invention;

FIG. 12 is a flow chart exemplifying an operation of plug-in used in a remote desktop operation method according to an embodiment of the present invention;

FIG. 13 describes a transition of application profile used in a remote desktop operation method according to an embodiment of the present invention;

FIG. 14 is a conceptual diagram exemplifying a functional comprisal of remote viewer used in a remote desktop operation method according to an embodiment of the present invention;

FIG. 15 is a conceptual diagram exemplifying a configuration of by-mode key allocation table used in a remote desktop operation method according to an embodiment of the present invention;

FIG. 16 is a conceptual diagram exemplifying a configuration of by-mode key allocation table used in a remote desktop operation method according to an embodiment of the present invention;

FIG. 17 is a flow chart exemplifying a login sequence for a remote desktop operation method according to an embodiment of the present invention;

FIG. 18 is a flow chart exemplifying a login sequence for a remote desktop operation method according to an embodiment of the present invention;

FIG. 19 describes a transition of screen display on an information terminal apparatus for a remote desktop operation method according to an embodiment of the present invention;

FIG. 20 is a flow chart exemplifying a preparation of remote operation for an application in a remote desktop operation method according to an embodiment of the present invention;

FIG. 21 describes a desktop on a server apparatus and a remote operation screen on an information terminal apparatus comparably with each other for a remote desktop operation method according to an embodiment of the present invention;

FIG. 22 exemplifies a display of display elements in hierarchical relationship for a remote desktop operation method according to an embodiment of the present invention;

FIG. 23 exemplifies a screen display of notifying of a state change in a remote desktop operation method according to an embodiment of the present invention; and

FIG. 24 is a flow chart exemplifying a notification of state change of application in a remote desktop operation method according to an embodiment of the present invention.

### DESCRIPTION OF THE PREFERRED EMBODIMENTS

The following is a detailed description of the preferred embodiment of the present invention while referring to the accompanying drawings. The following description deals with the case of applying an interface control technique of the present invention to a remote desktop operation technique as an example.

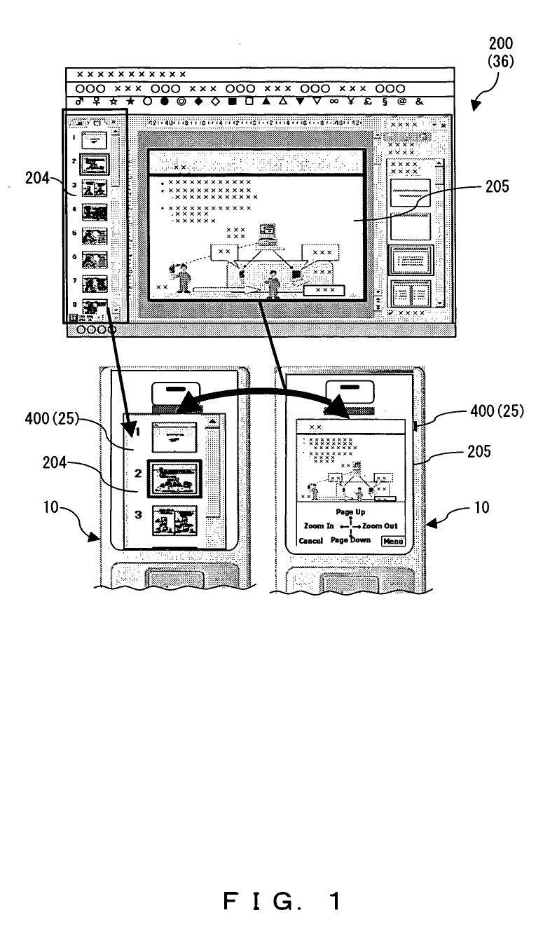

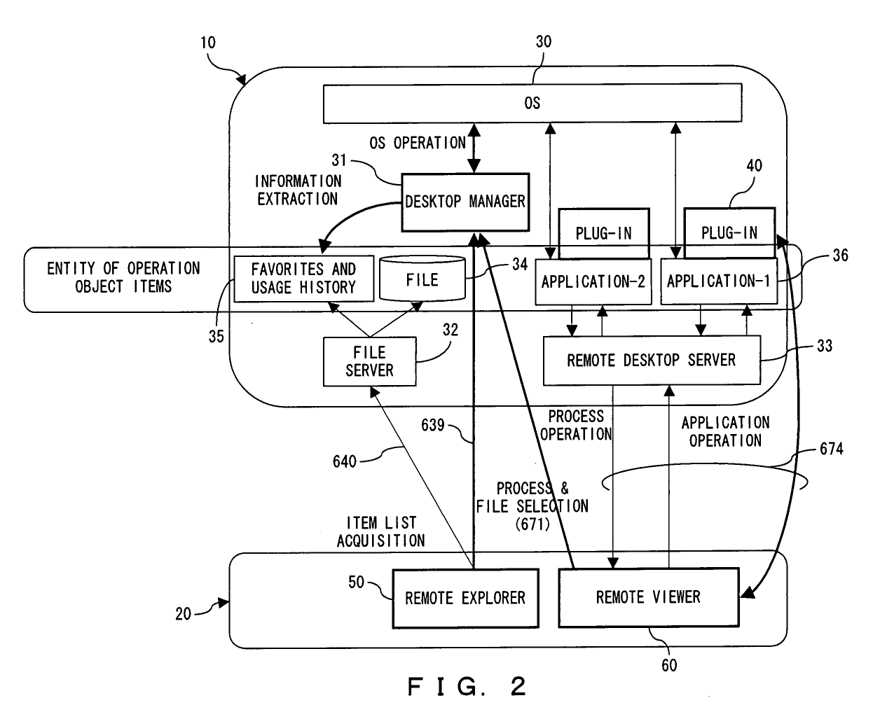

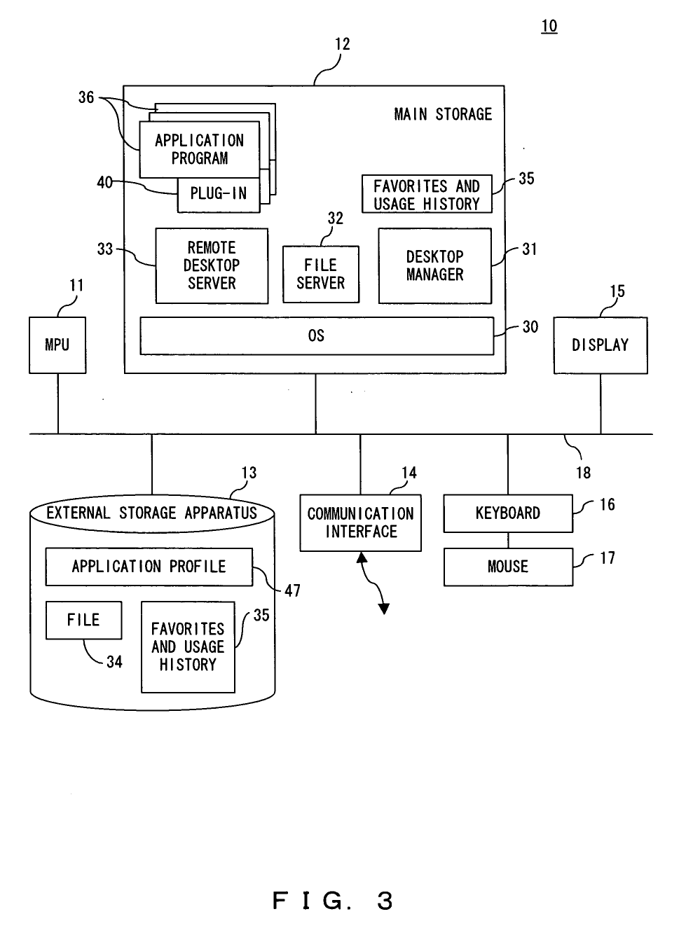

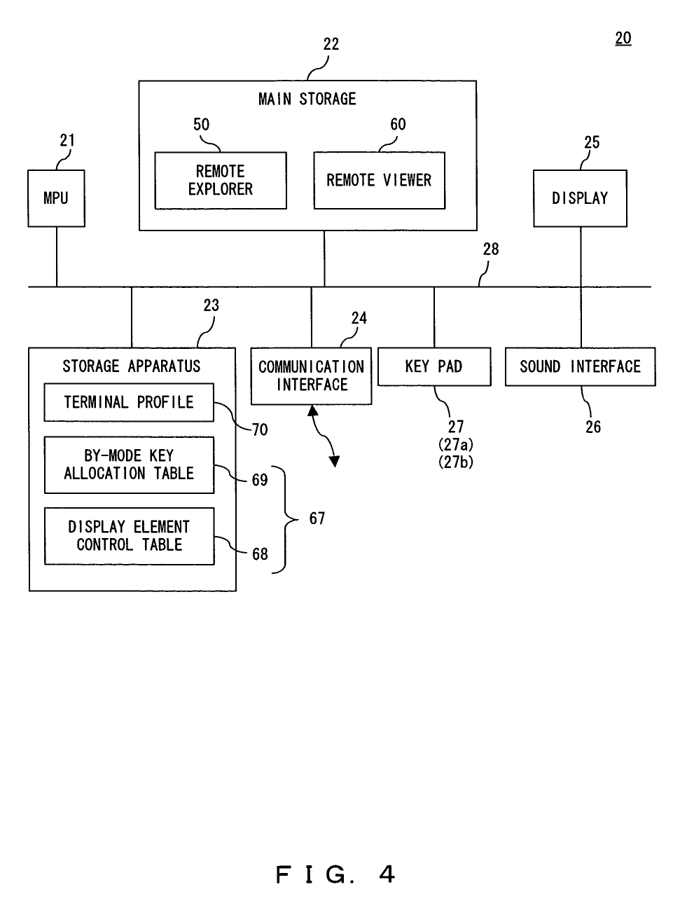

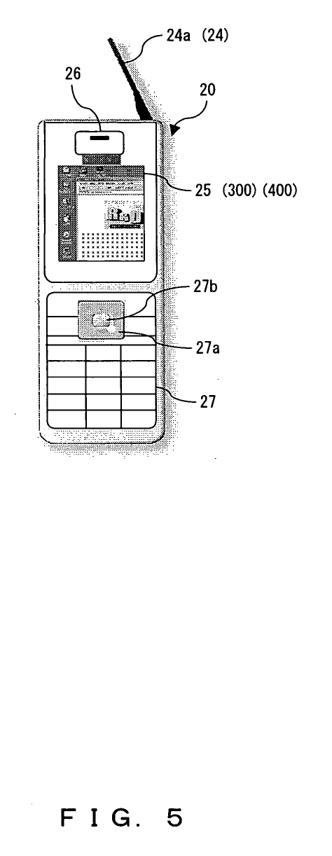

FIG. 1 is a conceptual diagram exemplifying a remote desktop operation method according to an embodiment of the present invention; FIG. 2 is a conceptual diagram exemplifying a comprisal of an information processing system for carrying out a remote desktop operation method according to an embodiment of the present invention; FIG. 3 is a conceptual diagram exemplifying a comprisal of server apparatus for carrying out a remote desktop operation method according to the present embodiment; FIG. 4 a conceptual diagram exemplifying a comprisal of information terminal apparatus for carrying out a remote desktop operation method according to the present embodiment; and FIG. 5 is a plain view exemplifying an external view of information terminal apparatus according to the present embodiment.

An information processing system according to the present embodiment includes a server apparatus 10 (i.e., first information processing apparatus) comprised by a stationary personal computer (PC), et cetera, and an information terminal apparatus 20 (i.e. second information processing apparatus) connected with the server apparatus 10 by way of an information network (not shown herein) such as a wireless communication network and public communication line.

The server apparatus 10 is installed by software such as an operating system 30, desktop manager 31 running thereon, file server 32, remote desktop server 33, application program (simply “application” herein after) 36 and plug-in 40 (i.e., interface control program).

And information resources (such as file 34, favorites and usage history 35) exist under the operating system 30.

Over at an information terminal apparatus 20, the installed software includes a remote explorer 50 and a remote viewer 60 for remote controlling the server apparatus 10 from the aforementioned information terminal apparatus 20.

As exemplified by FIG. 3, the server apparatus 10 according to the present embodiment includes a central processing apparatus 11, a main storage 12, an external storage apparatus 13, a communication interface 14, a display 15, a keyboard 16, a mouse 17 and a bus 18 for interconnecting these components as information transmission path.

The central processing apparatus 11, constituted by microprocessor unit (MPU), et cetera, for example, executes the operating system 30 and subordinate software stored in the main storage 12.

The main storage 12 stores software and data to be executed by the central processing apparatus 11. The present embodiment is configured to have installed an operating system 30, a desktop manager 31, a file server 32, a remote desktop server 33, an application 36, a plug-in 40, et cetera, in the main storage 12.

The external storage apparatus 13, constituted by a storage apparatus comprising a rewritable nonvolatile storage medium for example, stores a file 34, favorites and usage history 35, a later described application profile 47, et cetera.

The file 34, favorites and usage history 35, and application 36 are the entity of operation object items for the information terminal apparatus 20.

The communication interface 14, constituted by a wired or wireless communication interface, carries out information communication to the information terminal apparatus 20.

The display 15, constituted by a relatively large size panel display (e.g., XGA: 1024 by 768 pixels) for example, performs a visual display of information such as later described desktop 100, i.e., basic operation screen, and operation screen 200 for the application 36.

The keyboard 16 is used for an information input by the user for the operating system 30 and application 36. The mouse 17 is used for inputting information as a pointing device.

In the meantime, the information terminal apparatus 20 according to the present embodiment includes a central processing apparatus 21, a main storage 22, a storage apparatus 23, a communication interface 24, a display 25, a sound interface 26, a key pad 27 and a bus 28 interconnecting the aforementioned components, as exemplified by FIG. 4.

The central processing apparatus 21, constituted by microprocessor unit (MPU), et cetera, for example, executes software such as a remote explorer 50 and remote viewer 60 installed in the main storage 22, thereby accomplishing a remote access to the server apparatus 10.

The main storage 22 stores the software and data such as the remote explorer 50 and remote viewer 60 to be executed by the central processing apparatus 21.

The storage apparatus 23, constituted by a rewritable nonvolatile storage medium for example, stores information such as a later described terminal side application profile 67, terminal profile 70, et cetera.

The communication interface 24, constituted by a wireless communication interface for example, is used for an information communication with the server apparatus 10.

The display 25, constituted by a small size panel display apparatus (e.g., resolution by QVGA: 320 by 240 pixels), et cetera, for example, displays information for the user.

The sound interface 26, constituted by a microphone, speaker, et cetera, is used for an input & output of sound information for a speech communication such as telephone.

The key pad 27 is constituted by relatively small size and small number of keys, including a later described cursor key 27a, decision button 27b, et cetera.

In terms of convenience for description, the example herein has the main storage 22 and storage apparatus 23 separately, while they may be achieved by a common storage apparatus. Meanwhile, an equipment of camera (not shown herein) may be appropriate for functioning as a video phone.

Referring to an example shown by FIG. 5, the information terminal apparatus 20 according to the present embodiment equips itself with an antenna 24a for the communication interface 24, display 25, keypad 27, cursor key 27a and decision button 27b in a relatively small size chassis 29.

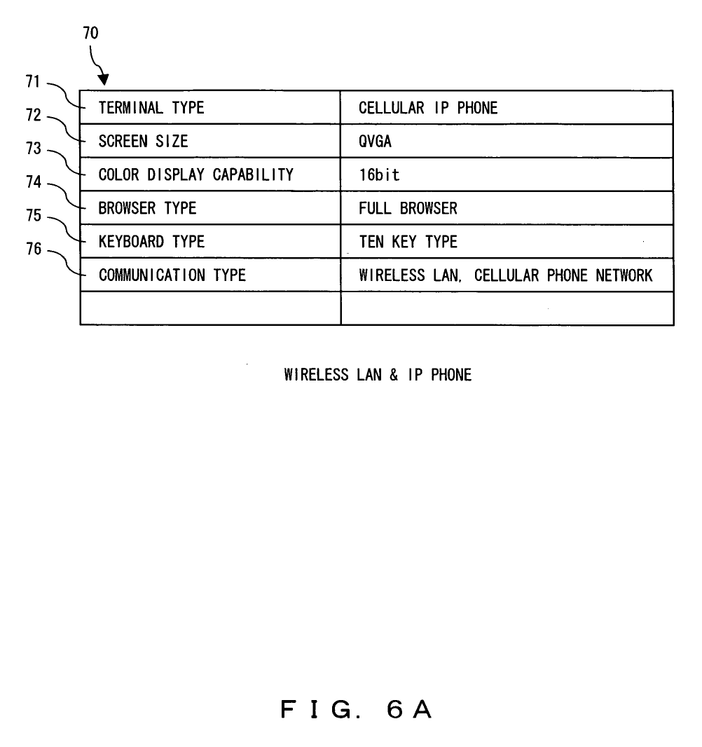

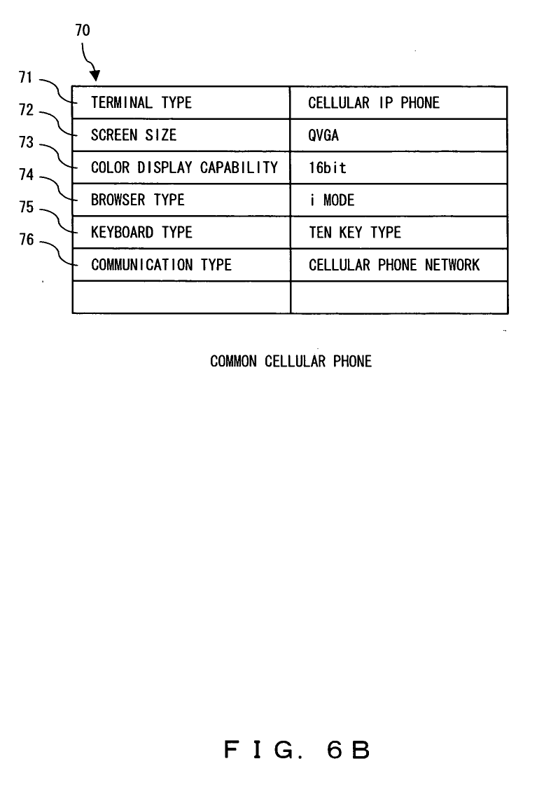

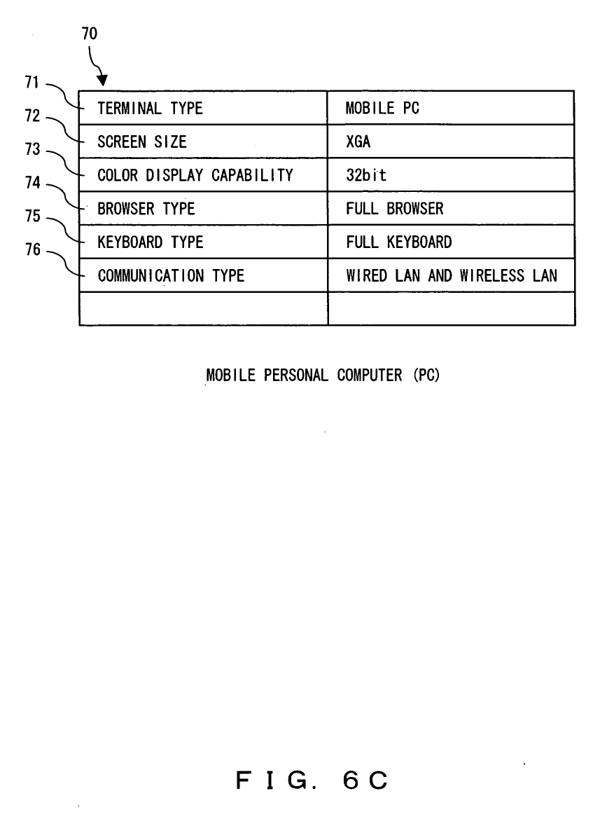

FIGS. 6A, 6B and 6C shows a setup example of the above described terminal profile 70 which comprises a terminal type 71, a screen size 72, a color display capability 73, a browser type 74, a keyboard type 75, a communication type 76, et cetera.

The terminal type 71 is set up with the information indicating a category of the information terminal apparatus 20 including “mobile IP (Internet Protocol) phone”, “cellular phone”, “mobile PC”, for example.

The screen size 72 is set up with the information indicating an image display size of the display 25 such as “QVGA: 320 by 240 pixels”, and “XGA: 1024 by 768 pixels”.

The color display capability 73 is set up with a bit value indicating the number of colors in the color display.

The browser type 74 is set up with a category of browser software such as the remote viewer 60 installed in the information terminal apparatus 20.

The keyboard type 75 is set up with the information indicating a category of the key pad 27.

The communication type 76 is set up with a category of medium (i.e., wired or wireless) in the communication interface 24.

Incidentally, FIG. 6A exemplifies a setup in the case of the information terminal apparatus 20 being a wireless LAN & IP phone; FIG. 6B exemplifies that of the information terminal apparatus 20 being a common cellular phone; and FIG. 6C exemplifies that of the information terminal apparatus 20 being a mobile PC.

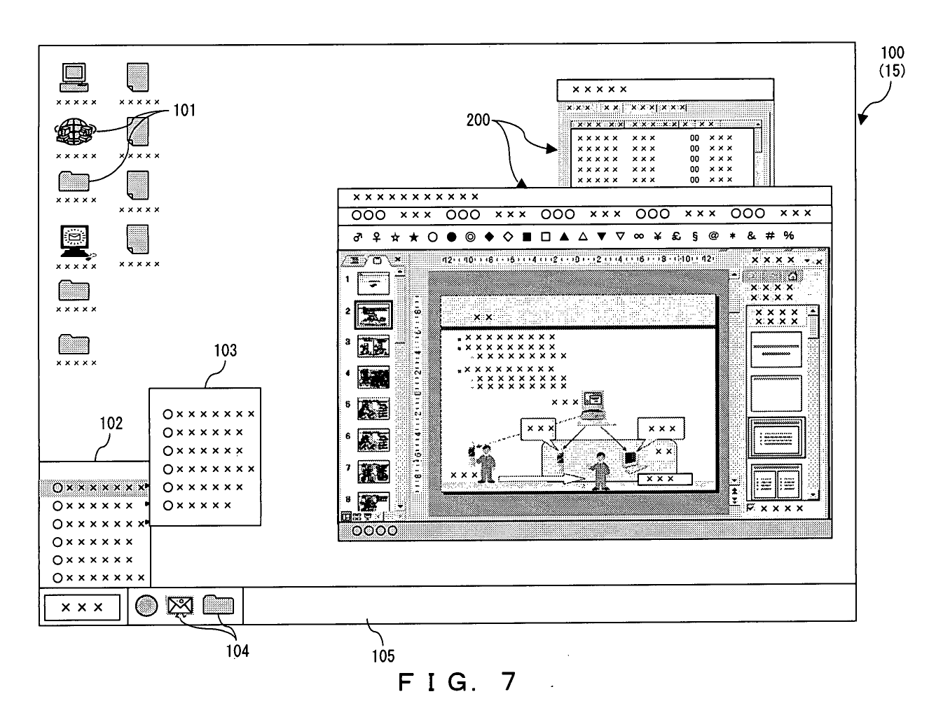

FIG. 7 exemplifies a desktop 100 as a basic operation screen displayed by the display 25 through a control by the desktop manager 31 in the information terminal apparatus 20.

The desktop 100 comprises display elements 36a, including an icon 101 correlated with an application, file, et cetera, a popup menu 102, a submenu 103, an operation button 104, an operation bar 105. And a user operation of these display elements 36a by the mouse 17 and/or keyboard 16 enables a startup of application 36 and an operation of the operating system 30 such as an operation of file.

Also at the server apparatus 10, the desktop 100 displays an operation screen 200 for the started-up application 36 as well.

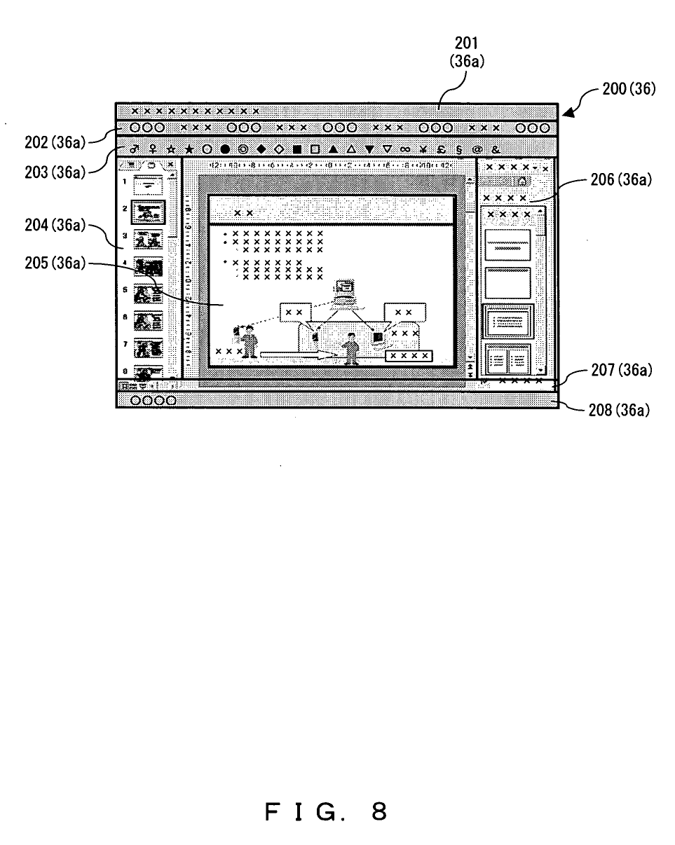

FIG. 8 is a conceptual diagram showing an example comprisal of the operation screen 200, which exemplifies an operation screen 200 in the case of the application, for instance, being presentation software for creating and displaying a material to be used at a presentation or conference. In the case of this presentation software, the operation screen 200 comprises the display elements 36a, including a tool bar 201, a format setup bar 202, a ruled line bar 203, a slide catalog 204, a main panel 205, a layout selection panel 206, a graphics bar 207, a status notice bar 208, et cetera, for example.

As described above, the information processing system according to the present embodiment comprises the information terminal apparatus 20 possessed and operated by a user, and the server apparatus 10 for retaining and carrying out the desktop 100 and application 36 to be operated.

The operating system 30 installed in the server apparatus 10 manages the entirety thereof integrally and also controls an execution of the application 36 for the user.

The remote desktop server 33 takes part in a basic desktop remote control such as transmitting a screen of the desktop 100 to the server apparatus 10.

The file server 32 carries out a processing of disclosing a file 34 and used process (e.g., program) of the user to the server apparatus 10 in a form of list (e.g., a later described application list 301).

The desktop manager 31 notifies the file server 32 of process information being executed in collaboration with the operating system 30 and operates on the operating system 30 in compliance with an instruction from the user and/or information terminal apparatus 20. The operation on the operating system 30 by the desktop manager 31 at least includes a size change, a location change (e.g. a coordinate change), maximization, iconization and normalization in the operation screen 200 for the application 36. And the desktop manager 31 at least has the functions of obtaining information about the application 36 run by the user from the operating system 30 and putting data in order so that the file server 32 can disclose the data in a remote desktop environment 300, i.e., an initial terminal screen, as an application list 301. Display elements 36a by the plug-in 40 is also recorded in the application list 301 as sub-items 301a of the application 36.

And the present embodiment is configured to install, in each of the applications 36, a plug-in 40 for carrying out a special operation other than a usual keyboard operation according to an instruction from the user and/or information terminal apparatus 20. It is not necessary to install the plug-in 40 in all the applications 36, but a later described special operation by using the plug-in 40 is not possible and therefore only a special operation by way of the operating system 30 by using the desktop manager 31 is available, in addition to usual operations.

The remote explorer 50 installed in the information terminal apparatus 20 obtains an item such as a process including the user operable file 34, application 36, et cetera, from the file server 32 of the server apparatus 10 and displays in the display 25 as a remote desktop environment 300.

The remote viewer 60, while displaying the remote desktop environment 300 in collaboration with the remote desktop server 33 on the information terminal apparatus 20, becomes a “contact window” for the desktop manager 31 of the server apparatus 10 and the plug-in 40 of each application 36. The remote viewer 60 provides not only a usual operation by using a keyboard and mouse as handled by a common remote desktop, but also an interface for a later described special operation by using the desktop manager 31 and/or plug-in 40.

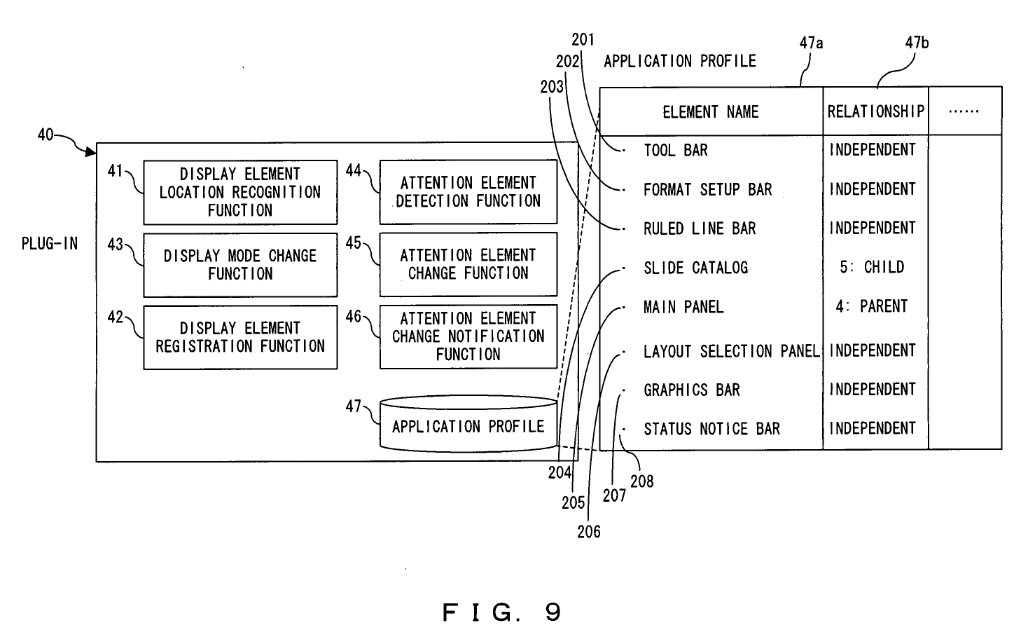

The next description is about the plug-in 40 according to the present embodiment in further detail while referring to FIG. 9 which is a block diagram exemplifying a functional comprisal of the plug-in 40.

The plug-in 40 according to the present embodiment, installed for each application 36, obtains information about the applicable application 36 and provides an operation interface for accomplishing a special operation which is not possible with a keyboard or pointing device.

The plug-in 40 includes a display element location recognition function 41, a display element registration function 42, a display mode change function 43, a focus element detection function 44, a focus element change function 45, a focus element change notification function 46 and an application profile 47.

The application profile 47 retains basic information about the application 36 and internal elements.

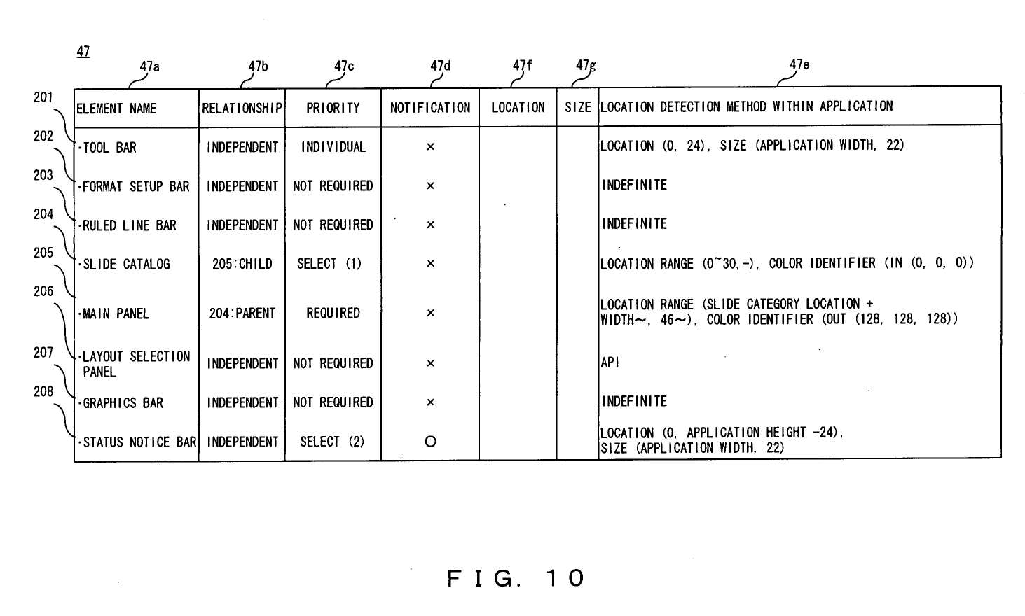

FIG. 10 is a conceptual diagram showing an example comprisal of the application profile 47 which includes an element name 47a, relationship information 47b, a priority 47c, a notification presence & absence information 47d, an element location detection method 47e, an element location 47f and an element size 47g.

The element name 47a identifies the constituent elements (i.e., tool bar 201 through status notice bar 208 in this example) constituting the operation screen 200 of the application 36.

The relationship information 47b indicates a hierarchical relationship and dependent relationship between each element identified by the element name 47a.

The priority 47c indicates a display method for each element identified by the element name 47a, setting up with “individual display”, “display not required”, “display required”, “selective display” (i.e., automatically decided over at the information terminal apparatus 20), et cetera.

The notification presence & absence information 47d sets whether or not to send a notification over to the information terminal apparatus 20 when an event relating to each element identified by the element name 47a occurs.

The element location detection method 47e is information indicating by which of later described methods is to recognize each element identified by the element name 47a.

The element location 47f is the location value of an element recognized by a method of the element location detection method 47e.

The element size 47g is the size value of an element recognized by a method of the element location detection method 47e.

The display element location recognition function 41 recognizes all the display elements 36a (i.e., tool bar 201 through status notice bar 208 in this example) contained by the operation screen 200 (as per GUI) of the application 36.

The display element registration function 42 registers all display elements 36a selected for display by a characteristic of the information terminal apparatus 20 from among all the display elements 36a recognized by the display element location recognition function 41 in the application list 301.

The display mode change function 43 changes a display mode and selects display parts in compliance to an instruction from the information terminal apparatus 20.

The focus element detection function 44 detects a focus element (i.e., either one of tool bar 201 through status notice bar 208 in this example) currently focused by the user in the operation screen 200.

The focus element change function 45 changes focus elements in compliance with an instruction from the information terminal apparatus 20.

The focus element change notification function 46 notifies the information terminal apparatus 20 when the focus elements are changed by the application 36 on the other hand.

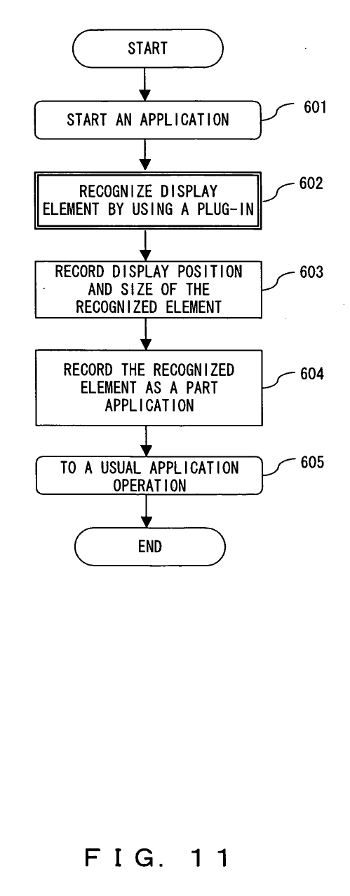

FIG. 11 is a flow chart exemplifying an operation of the plug-in 40 at startup of the application 36.

When the application 36 is started up in the server apparatus 10 (step 601), the plug-in 40 also starts up if the one exists. When the user operates directly on the server apparatus 10, the plug-in 40 carries out a display element location recognition by the display element location recognition function 41 (step 602), records in the application profile 47 (step 603), and register an element by the display element registration function 42 (step 604) only, followed by a transition to a usual operation of application 36 on the server apparatus 10 (step 605).

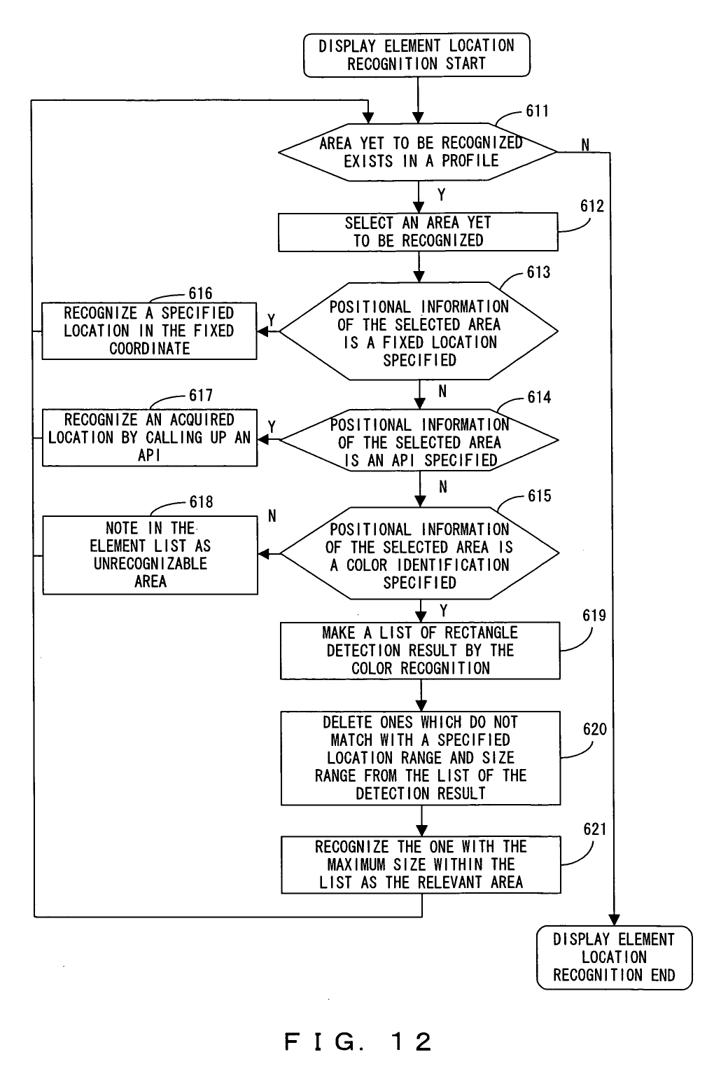

A recognition of display element location (i.e., the processing of the above described step 602) by the display element location recognition function 41 is carried out by the flow chart exemplified by FIG. 12.

A rectangular area is detected corresponding to each display element 36a such as a tool bar 201 through status notice bar 208 existing in the element list within the application profile 47. There are three kinds of detection methods for the rectangular area, so that a detectable display element 36a is specified by either one of the following as a location detection method within the operation screen 200, i.e., (1) specification by a fixed location, (2) acquisition of location by calling up an API (application program interface), or (3) recognition of rectangle by color identification. A display element 36a without any or the aforementioned methods being specified is recorded as an unrecognizable area by the application profile 47.

A specification by a fixed location is done by a fixed value or by using the width and height of the operation screen 200 for the application 36 and those of another display element 36a. In the case of using the location information of another display element 36a, the location information must not cause a circulation of dependency between locations. If a location of unrecognizable display element 36a, or the one of its own display elements, becomes necessary in the process of detecting the location of specific display element, the location of the current display element 36a becomes unrecognizable, hence being noted in the application profile 47.

A location acquisition method by calling up the API acquires the location of a target display element 36a by utilizing the API of the operating system 30 or application 36. This detection method is specified for a display element which is identifiable by the name as a result of being registered as a window on the operating system 30, or in the case the application 36 having prepared a location acquisition-use API as external API.

A location recognition by color recognition detects a display element 36a as rectangular area by specifying a color outside a rectangle or inside a rectangle with a specific color. In the case of specifying a color outside a rectangle, a GUI screen (i.e., operation screen 200) of the application is recognized as an image so as to detect a rectangular area bordered by the specified color. And, the case of specifying a color inside a rectangle will detect a rectangular area with the circumference being the specified color. Usually a plurality of rectangular areas by the specified color are detected, in which case the maximum among rectangular areas matching with a separately specified location range condition and size range condition will be detected as a display element 36a.

The above description will be summarized as follows. That is, referring to the flow chart shown by FIG. 12, when starting a display element location recognition starts, the first is to judge whether or not an area yet to be recognized exists (step 611), if there is one, select an area yet to be recognized (step 612), and, if the positional information of the selected area is a fixed location specified (step 613), recognize the specified location in the fixed location (step 616). If the positional information of the selected area is an API specified (step 614), recognize a location obtained by calling up the API (step 617), followed by going back to the step 611.

If the case is neither of the above described, judge whether or not the positional information of the selected area is a color identification specified (step 615) and, if it is not, note in the element list as an unrecognizable area (step 618) and go back to the step 611.

If the judgment result in the step 615 is a color identification specified, make a list of rectangular detection result according to the color recognition (step 619), delete ones which do not match with a specified location range and size range from the list of the detection result (step 620), followed by recognizing the one with the maximum size within the list as the relevant area (step 621).

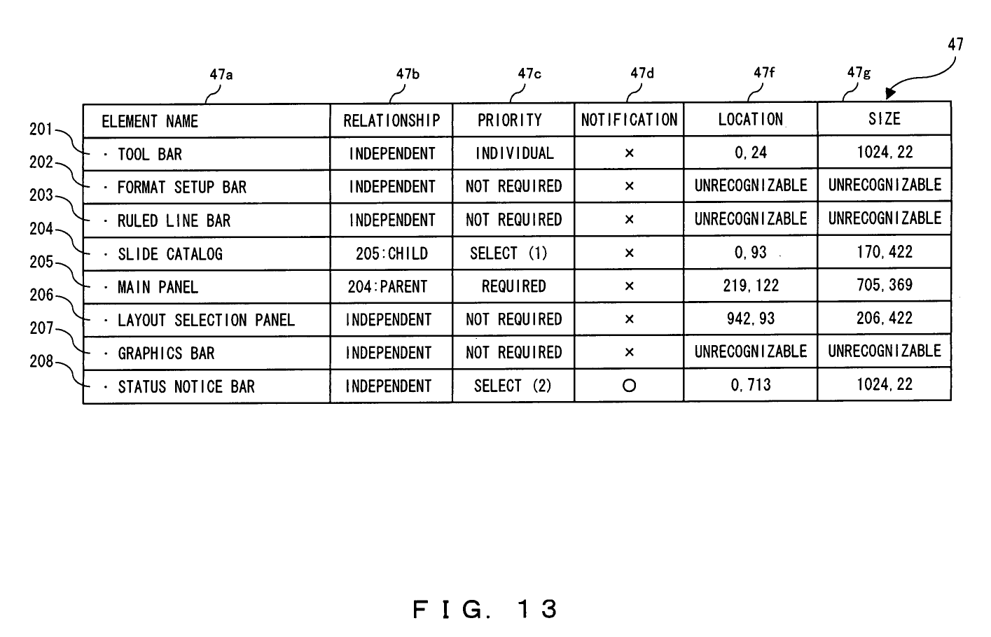

The above described processing will be repeated for all the display elements 36a within the operation screen 200. This acquires an application profile 47 containing an element location 47f and an element size 47g as exemplified by FIG. 13.

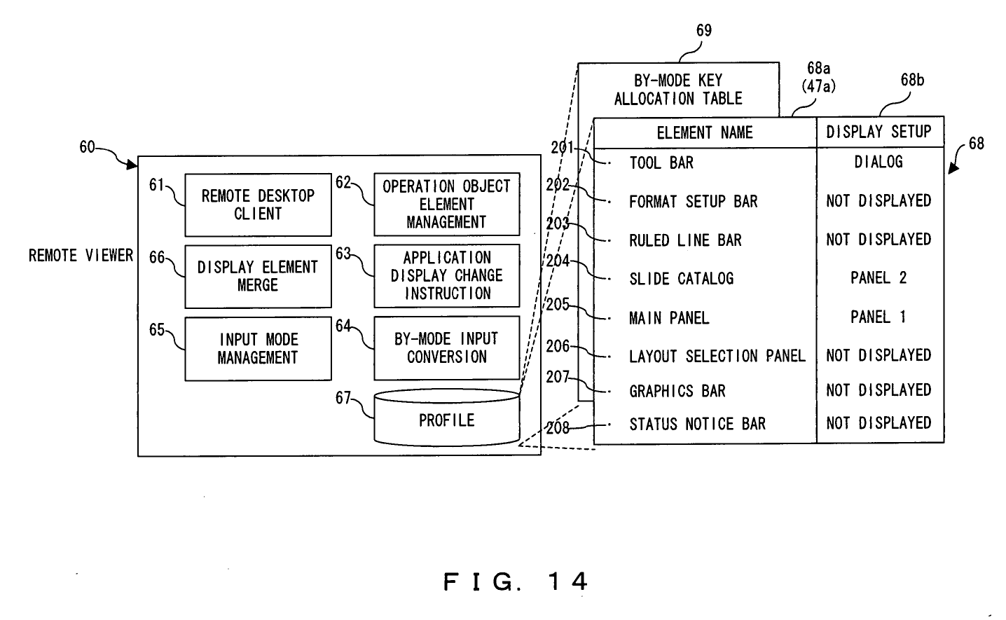

FIG. 14 is a conceptual diagram exemplifying a functional comprisal of remote viewer 60 which is installed in the information terminal apparatus 20.

The remote viewer 60 includes a remote desktop client function 61, an operation object element management function 62, a display change instruction function 63, a by-mode input conversion function 64, an input mode management function 65, a display element merge function 66 and a terminal side application profile 67.

The remote desktop client function 61 has the functions of obtaining a screen of the server apparatus 10 to display in the display 25 of the information terminal apparatus 20 as a client of the remote desktop server 33 on the server apparatus 10, and transmitting a user input to the remote desktop server 33 of the server apparatus 10.

The operation object element management function 62 manages as to which operation object on the server apparatus 10 the user focuses on.

The display change instruction function 63 instructs a display change of the application 36 according to the characteristic of the display in the information terminal apparatus 20 and the user instruction for a fine adjustment.

The terminal side application profile 67 includes a display element control table 68 and a by-mode key allocation table 69.

The display element control table 68 retains the display elements 36a (i.e., element name 68a), and display setup information 68b for indicating a on-off of displaying and display form relating to each of the aforementioned display elements 36a, for each application 36.

The by-mode key allocation table 69 holds, for each application 36, a key allocation table for indicating a correlation between the necessary key inputs (i.e., key inputs by the keyboard 16 on the server apparatus 10) and buttons in the key pad 27 on the information terminal apparatus 20 by input mode.

The by-mode input conversion function 64 converts the user input into being compliant to the application and input mode by utilizing the terminal side application profile 67 and transmits to server apparatus 10.

The input mode management function 65 manages the current input mode at the information terminal apparatus 20 by utilizing the terminal side application profile 67.

The display element merge function 66 merges a plurality of display elements 36a into one screen to output to the display 25.

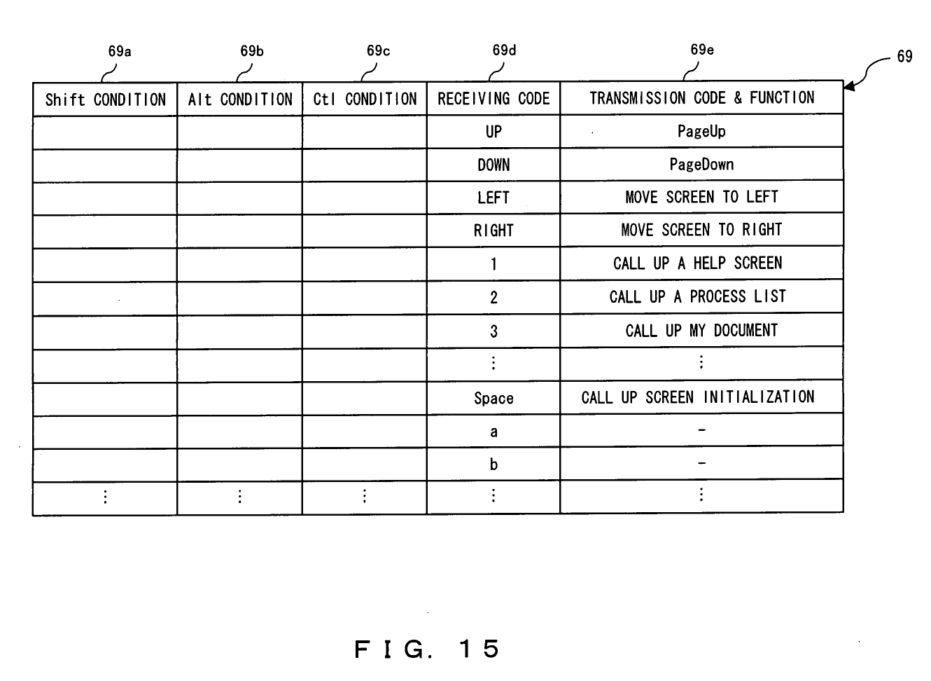

FIG. 15 is a conceptual diagram exemplifying a configuration of the by-mode key allocation table 69 which includes a Shift condition 69a, an Alt condition 69b, a Ctrl condition 69c, a receiving code 69d and a transmission code & function 69e.

The receiving code 69d indicates receiving codes corresponding to pressing each key on the key pads 27, cursor key 27a and decision button 27b; and set, in each of the Shift condition 69a, Alt condition 69b and Ctrl condition 69c, as to whether or not the receiving codes are to be modified to make them have different meanings when key inputs are made by pressing “Shift key”, “Alt key” and “Ctrl key” (these are not shown herein) of the key pad 27.

The transmission code & function 69e specifies the operations to be accomplished by the application 36 at the information terminal apparatus 20 corresponding to respective receiving codes 69d and the ones modified by the Shift condition 69a, Alt condition 69b and Ctrl condition 69c.

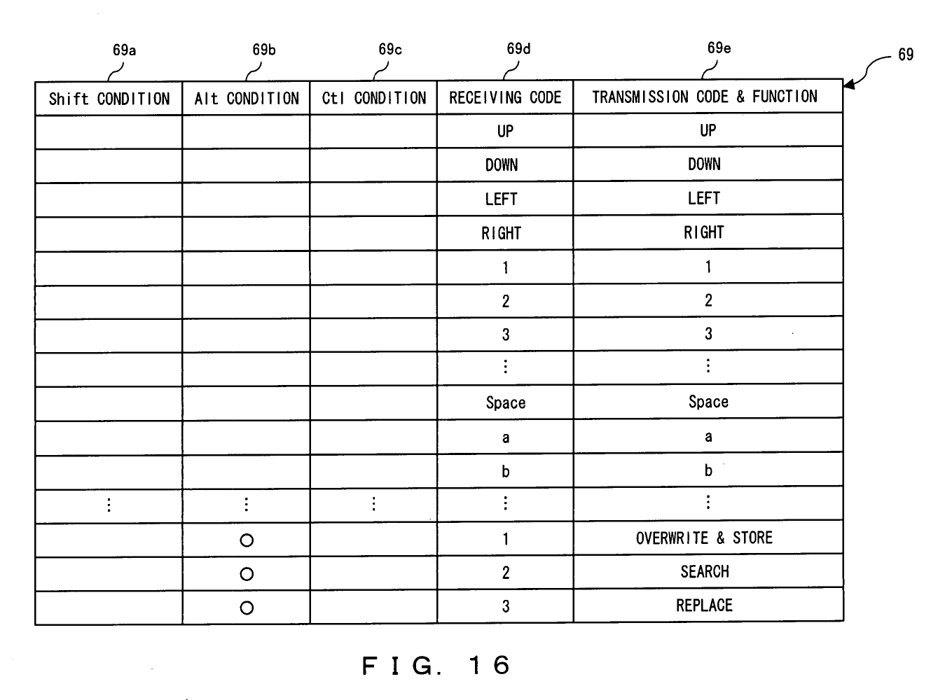

Note that FIG. 15 is a setup example for utilizing an application 36 for a document creation in a viewer mode from the information terminal apparatus 20. And that FIG. 16 is a setup example for utilizing an application 36 for a document creation in an edit mode from the information terminal apparatus 20.

The following description deals with the example operations of the server apparatus 10 and information terminal apparatus 20 in the remote desktop operation method according to the present embodiment.

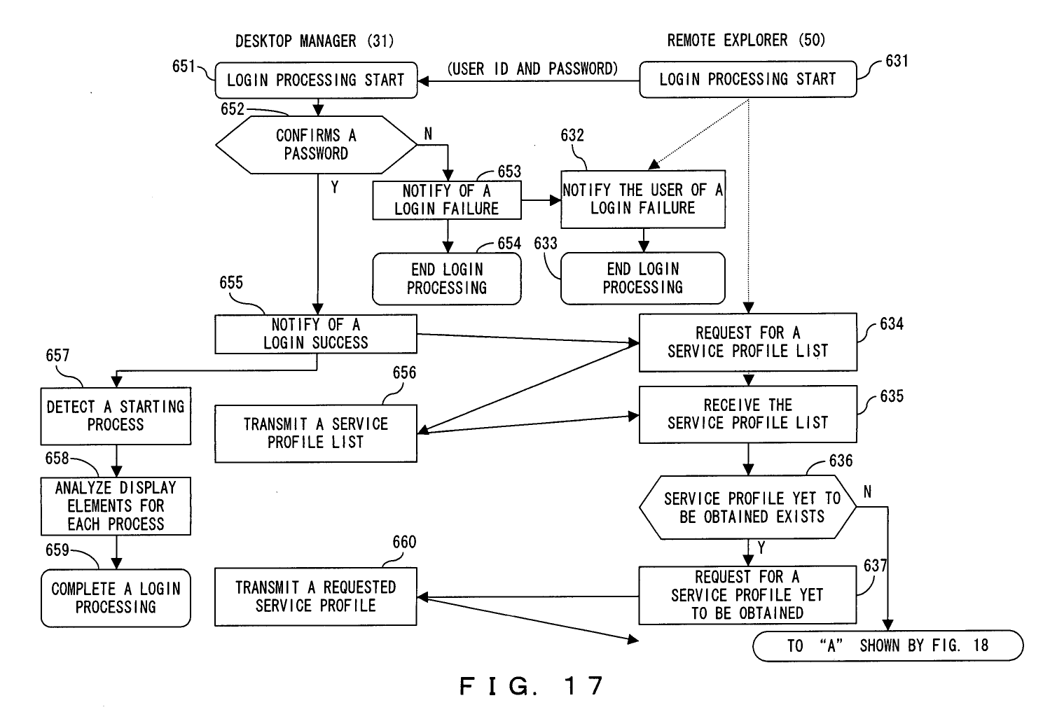

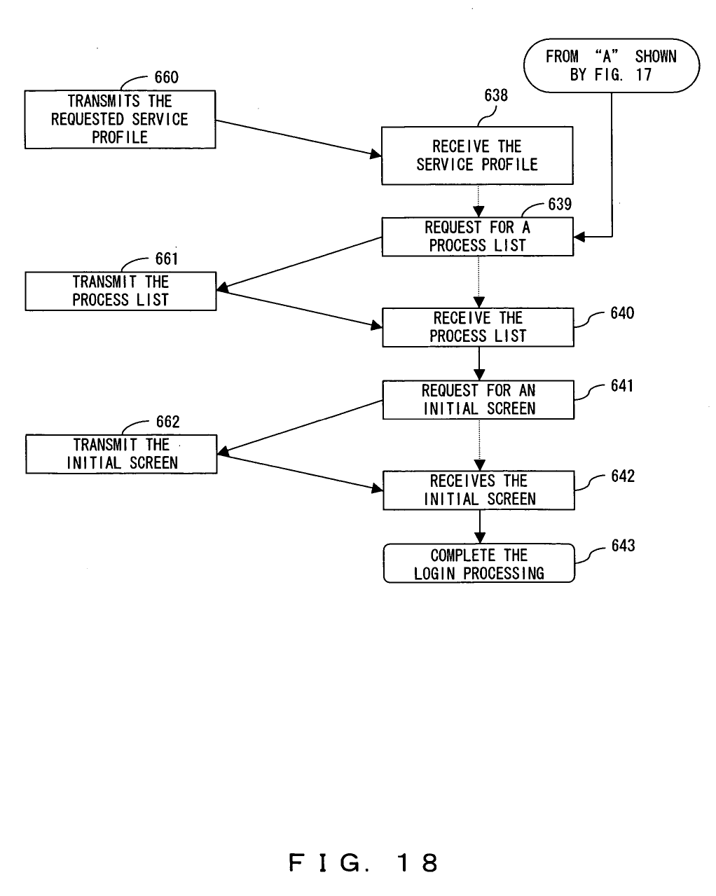

To begin with, let it describe an example of login sequence for the information terminal apparatus 20 to access to the server apparatus 10 while referring to FIGS. 17 and 18. Referring to FIGS. 17 and 18, note that the steps 631 through 643 show the operation of the remote explorer 50 installed in the information terminal apparatus 20, while the steps 651 through 662 show the operation of the desktop manager 31 over at the server apparatus 10.

At the login start, the remote explorer 50 transmits information about a user ID and password inputted by the user of the information terminal apparatus 20 to the desktop manager 31 so as to receive the information (step 631 and step 651).

The desktop manager 31 confirms the received password (step 652) and, if the password is incorrect, notifies the remote explorer 50 of a login failure (step 653) to end the login processing (step 654).

Having received this, the remote explorer 50 notifies the user of the login failure (step 632) to end the login processing (step 633).

If the password is judged to be correct in the step 652, the desktop manager 31 notifies the remote explorer 50 of a successful login (step 655), while the remote explorer 50, having received the notification, requests the desktop manager 31 for a service profile list (step 634) so that the desktop manager 31 transmits the service profile list to the remote explorer 50 (step 656) which receives it (step 635).

Meanwhile, in parallel with the transmission processing of the step 656, the desktop manager 31 detects a process such as an application starting up over at the server apparatus 10 (step 657), analyzes display elements 36a for each process (step 658) and ends the login process (step 659).

Then, the remote explorer 50 looks into a presence of yet to be obtained service profile such as application profile 47 (step 636) and, if there is a service profile yet to be obtained, requests the desktop manager 31 for the aforementioned service profile (step 637) so that the desktop manager 31 transmits the requested service profile to the remote explorer 50 in response to the request (step 660) and the remote explorer 50 accordingly receives the service profile (step 638).

On the other hand in the above described step 636, if the remote explorer 50 decides that there is no service profile yet to be obtained, the remote explorer 50 requests the desktop manager 31 for a process list (i.e., application list 301) (step 639), while the desktop manager 31 transmits the process list to the remote explorer 50 in response to the request therefrom (step 661) and the remote explorer 50 receives the process list accordingly (step 640).

Subsequently, the remote explorer 50 requests the desktop manager 31 for an initial screen (i.e., remote desktop environment 300) (step 641), while the desktop manager 31 transmits the initial screen to the remote explorer 50 in response to the request (step 642), which completes the login processing at the information terminal apparatus 20 (step 643).

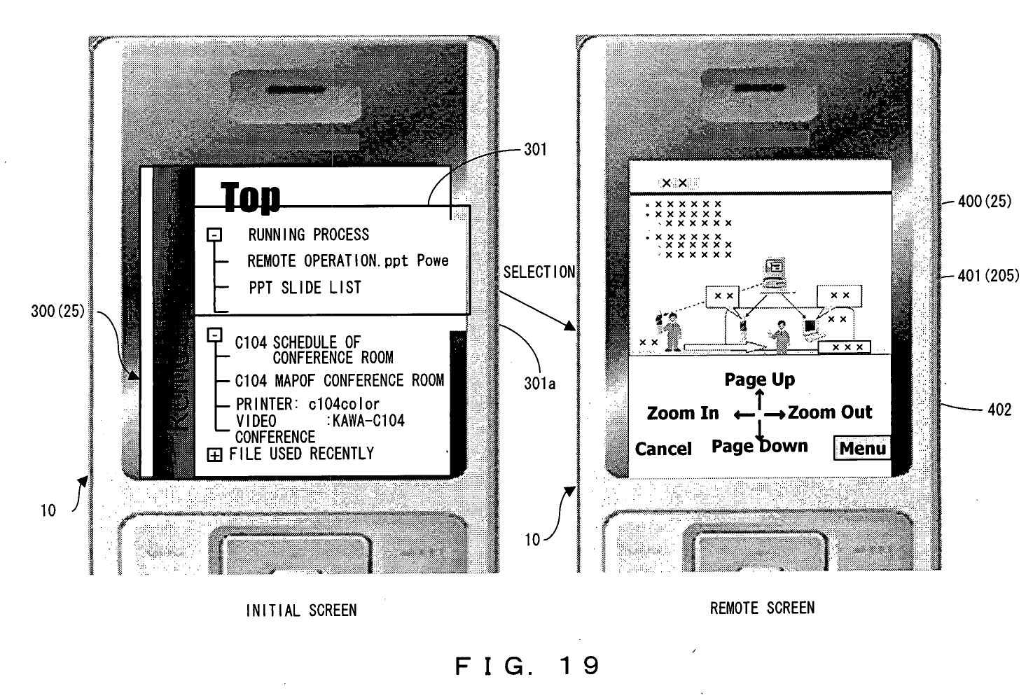

The left side of FIG. 19 shows an example display of initial screen (i.e., remote desktop environment 300) on the information terminal apparatus 20 at a login processing.

The remote desktop environment 300 displayed in the display 25 of the server apparatus 10 shows an application list 301 which shows, a sub-item 301a which is an application corresponding to each of the display elements 36a of the operation screen 200 for the current application 36, in addition to each application utilizable in the server apparatus 10.

Meanwhile, the right side of FIG. 19 shows a remote operation screen 400 on the information terminal apparatus 20 for an application 36 selected as later described. The remote operation screen 400 comprises a remote display area 401, and an operation guide area 402. The remote display area 401 displays one or a plurality of display elements 36a (i.e., main panel 205 in this example) of the application 36 for example.

And the remote display area 401 can display a display element(s) 36a of an application while switching as exemplified by FIG. 1.

The operation guide area 402 displays an operation guide applicable to the key pad 27 on the information terminal apparatus 20 and the input mode at the time.

The next description is about an example operation of the information terminal apparatus 20 when operating the server apparatus 10 remotely.

When the information terminal apparatus 20 starts operating the server apparatus 10 remotely, the remote explorer 50 first accesses to the file server 32 to obtain an operation object item list which is the link list of the items below: files stored in a public folder by the user, recently used files (i.e., file usage history), running applications 36, the favorites & usage history 35, et cetera. The aforementioned items are put in order by the desktop manager 31 by using the file 34 and API on the operating system 30 so that the file server 32 can disclose these items.

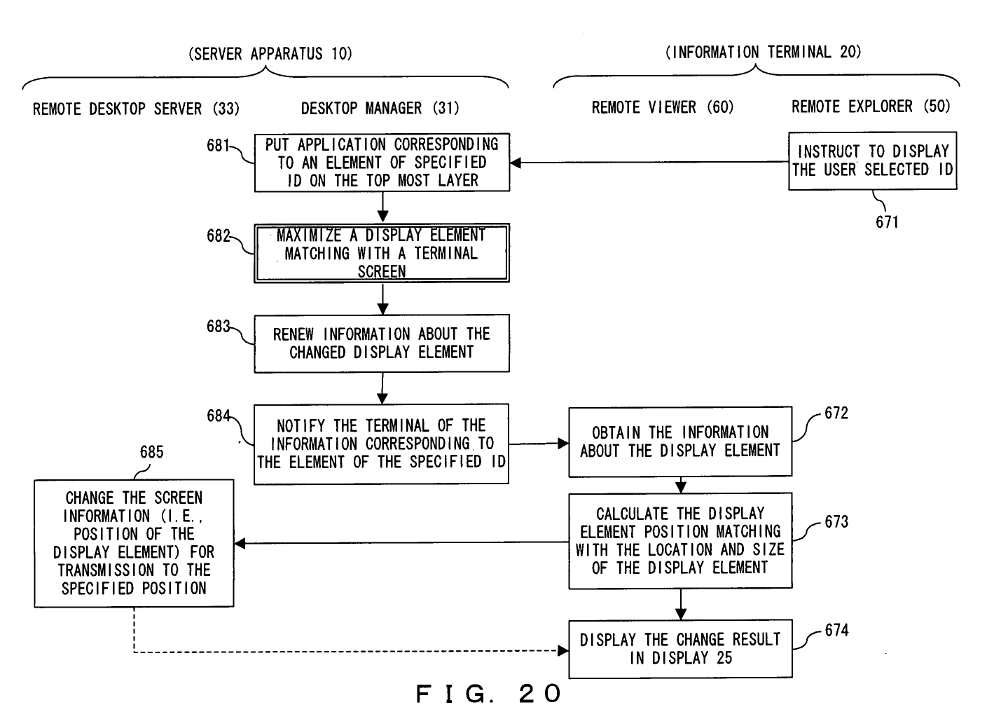

If the user specifies an application 36 running on the server apparatus 10 or the display elements 36a of the operation screen 200 for the application 36, the information terminal apparatus 20 and server apparatus 10 prepare for a remote operation of the application 36 through the processing exemplified by FIG. 20.

That is, having been notified of an ID of application 36 instructed by the user through information terminal apparatus 20, the desktop manager 31 on the server apparatus 10 (step 671) changes a display so that the information terminal apparatus 20 can display the applicable application 36 and the display elements 36a on the top most screen face and in the maximum size based on terminal information about the notified information terminal apparatus 20 (steps 681 and 682).

While the maximization of display actually operates differently depending on application 36 or display element 36a, in which an application size is changed so that the size of the display element 36a matches with the screen size of the display 25 on the information terminal apparatus 20, or the font size is changed, or the display magnification within the application 36 for example (step 683). The display mode change function 43 included in the plug-in 40 is specified in advance by how each application 36 or display elements 36a is to change such a display size.

After changing the display of the application 36 and display element 36a, notify the remote viewer 60 on the information terminal apparatus 20 (step 684).

Having received the application information, the remote viewer 60 of the information terminal apparatus 20 (step 672) calculates the position of the display elements 36a matching with the location and size of the current display elements 36a and notifies the remote desktop server 33 (step 673).

Having received this, the remote desktop server 33 changes the screen information (i.e., the position of the display elements 36a) to be transmitted to the information terminal apparatus 20 to the specified position (step 685), while the remote viewer 60 over at the information terminal apparatus 20 changes the location of obtained screen to the received location by using a common remote desktop function (i.e., remote desktop client function 61), displays a focused display element 36a of the application 36 at the server apparatus 10 in the display 25 thereof so as to let the user operate the application (step 674).

At the same time, selects an applicable input key table (i.e., by-mode key allocation table 69) from the terminal side application profile 67 based on the obtained application information so as to assist a user input.

Fine adjustment of display according to the user objective continue subsequently by calling up display mode change function 43 of the plug-in 40 in response to special operations by the user such as an enlarged or reduced size display, et cetera.

And if the user specifies a file 34 held by the server apparatus 10 by way of the remote explorer 50, an application 36 relating to the file 34 by the operating system 30 installed by the server apparatus 10 is started up so as to prepare for a remote operation of the application 36 through the same processing described in the flow chart shown by FIG. 20.

If the user specifies a link URL (uniform resource locator) by way of the remote explorer 50, an application 36 relating to the link on the operating system 30 installed by the server apparatus 10 is started up, followed by starting up a prescribed browser if it is an HTTP (Hyper Text Transfer Protocol) or application such as mailer if it is a mail address, so as to prepare for a remote operation of the application through the same processing described in the flow chart shown by FIG. 20.

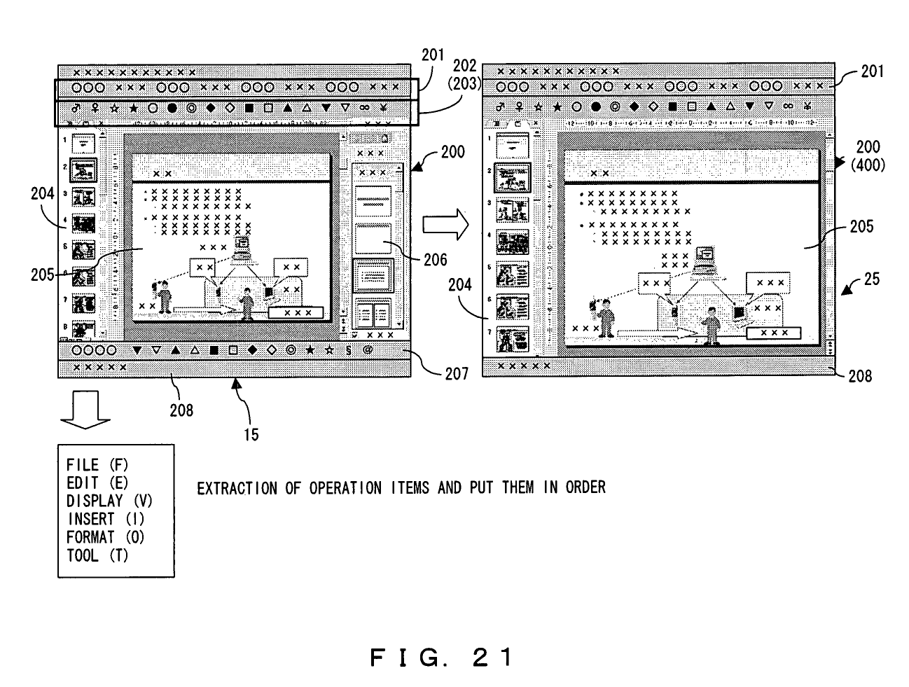

FIG. 21 shows an example of changing a displaying state of an operation screen of the application 36 on the information terminal apparatus 20 automatically by the plug-in 40. FIG. 21 exemplifies the case of displaying in the display 25 (i.e., remote desktop environment 300) of the information terminal apparatus 20 in a display form omitting a part of the display elements 36a such as the format setup bar 202, ruled line bar 203, layout selection panel 206, graphics bar 207 within the operation screen 200 based on the terminal profile 70. It is also possible to rearrange the operation item in the tool bar 201.

The above described display elements 36a exemplify the case of existing visually in the normal state of the operation screen 200, while if a plurality of display elements 36a are hierarchically layered, it is possible to recognize each of the hierarchical layers as the operation object display elements 36a recursively, thereby controlling a display form for the information terminal apparatus 20.

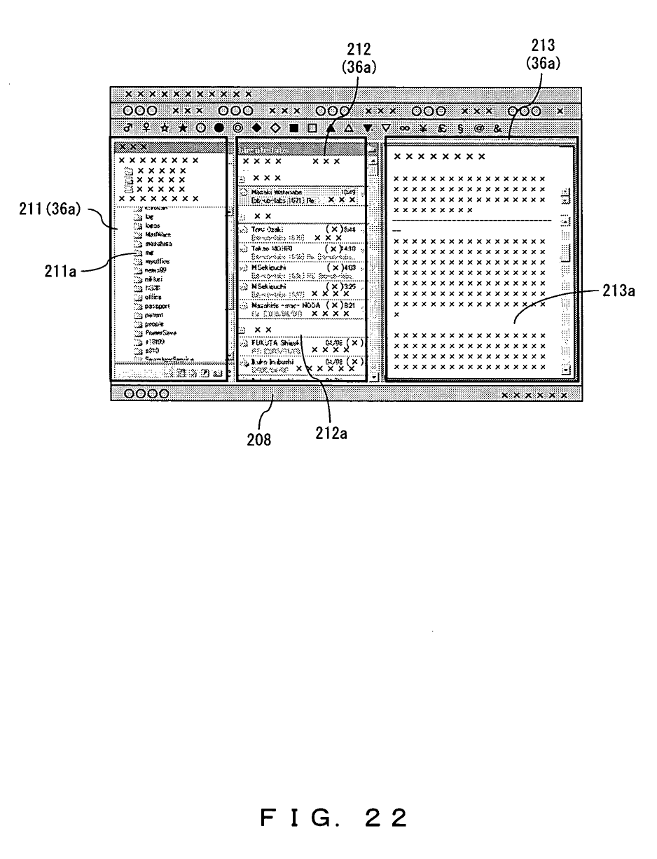

That is, FIG. 22 exemplifies an operation screen 200 of application 36 such as a mailer. In the operation screen 200, the content of each folder 211a in a folder list part 211, i.e., display elements 36a, is displayed in a mail file list part 212, i.e., display elements 36a on one layer down by specifying the aforementioned folder 211a; and furthermore, a mail content 213a is displayed in a mail check part 213, i.e., display element 36a on one more layer down, by specifying a plurality of mail files 212a displayed in the mail file list part 212.

In this case, a registration of the folder list part 211, mail file list part 212 and mail check part 213 in the application profile 47 as display elements 36a enables a display control for the information terminal apparatus 20. In this case, a hierarchical relationship among the folder list part 211, mail file list part 212 and mail check part 213 is specified in the relationship information 47b.

Incidentally, a notification attribute (i.e., notification presence & absence information 47d) is specified for a display element 36a for which the application 36 notifies information to the user among each display element 36a in the application profile 47 as described above. A display element 36a attached by the notification attribute notifies the user of a state of the application 36 by a change of icon configuration, et cetera.

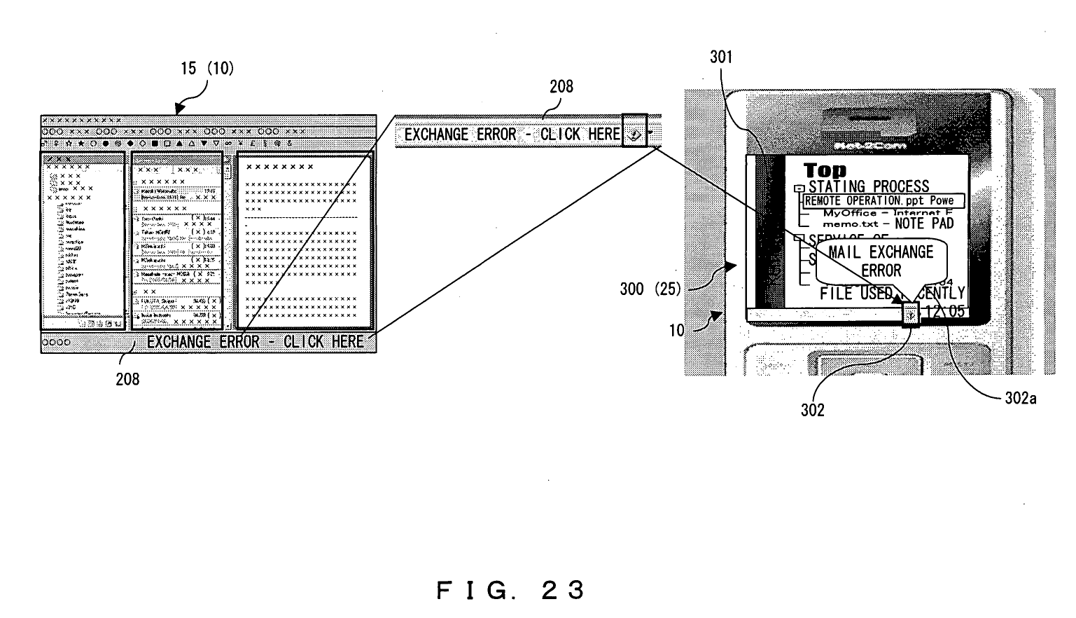

The present embodiment is configured so that the remote viewer 60 notifies the user of a notice from unselected application 36 by equipping a change notification display part 302 in a part of the remote desktop environment 300 as exemplified by FIG. 23, in addition to the user specified application 36 and display element 36a by using the display element merge function 66.

The example shown by FIG. 23 outputs an error message “mail exchange error” by a pop up display 302a in a change notification display part 302 featured at the lower end of the remote desktop environment 300 over at the information terminal apparatus 20 if a message “mail exchange error” is outputted at the status notice bar 208 in the operation screen 200 of an application 36, such as a mailer, running in the server apparatus 10.

The plug-in 40 running in the server apparatus 10 transmits the location information of the application 36 and display elements 36a specified by a notification attribute among them to the remote viewer 60. The plug-in 40 running in the server apparatus 10 monitors a change in contents of display elements 36a with the respective notification attributes so as to notify the remote viewer 60 running in the information terminal apparatus 20 when content changes such as a change in icon.

The remote viewer 60 furnishes the lower part of the display of the remote desktop environment 300 with the change notification display part 302 with the best possible size icon (e.g., in the neighborhood of 16 to 32 pixels). The remote viewer 60 displays a display element 36a with a notification attribute in the change notification display part 302 for a user specified prescribed time period (e.g., approximately between 10 seconds to 2 minutes) based on a notification attribute element or content change notice sent over from the server apparatus 10. If a size does not match, a displaying is carried out by reducing the size to match with the height and width of the change notification display part 302. If there are many display elements to be displayed, overflowing the change notification display part 302, all the display elements 36a with the respective notification attributes will be displayed in a time division while they are scrolled horizontally.

The user is enabled to select a specific notification element within the change notification display part 302 by using the function of the remote viewer 60 and display it in the terminal screen (i.e., display 25) in a maximum size. The method for the screen maximization is in accordance with the flow chart presented by FIG. 20.

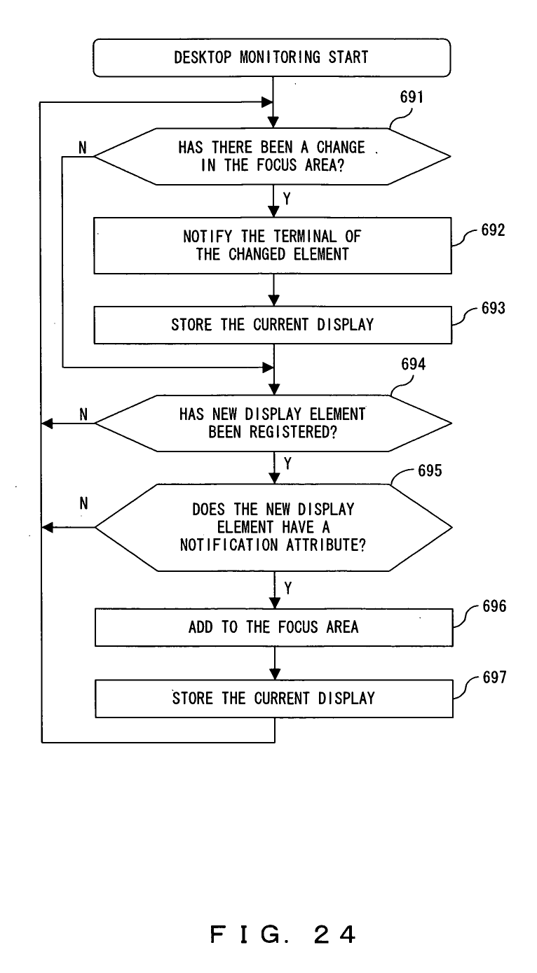

FIG. 24 is a flow chart exemplifying a change notification processing in the above description by the plug-in 40 which monitors a presence or absence of change in a focus area specified by the notification presence & absence information 47d noted in the application profile 47 (step 691), notifies the information terminal apparatus 20 of the changed display element 36a (step 692), and stores the display state at the current time (step 693).

Then the plug-in 40 monitors a registration of new display element 36a (step 694) and, if one has been registered, further examines whether or not a notification attribute is specified by the notification presence & absence information 47d (step 695) and, if the notification attribute is specified, adds to the focus area (step 696), and stores the display state at the current time (step 697).

As described above, the present embodiment is configured to let the plug-in 40 furnished for each application 36 recognize the display elements 36a in the operation screen 200 of the respective application 36 and transmit each display element 36a or a combination thereof as unit to the information terminal apparatus 20 so as to display and operate, thereby accomplishing a remote desktop operation environment matching with a capability of the information terminal apparatus 20 such as mobile terminal in terms of screen display form and operation, while maintaining the operation content of the standard desktop 100 for the server apparatus 10 such as a PC for example.

It is also possible to optimize diverse operation interfaces for the operating system 30 and/or each application 36 in matching with the capability of the information terminal apparatus 20 for the remote desktop operations.

Note also, it goes without saying that the above described comprisal of the present embodiment in no way limits the present invention, and rather a various changes are possible within the scope thereof.

For example, while the above description has taken example of operating an application program remotely, the present invention is also applicable to a remote operation of various utility programs with the GUI based operation screen, respectively, which constituting a part of operating system, instead of being limited by the present example.

The present invention is comprised to accomplish a remote desktop environment matching with a capability of information terminal such as a mobile terminal in terms of screen display form and operation, while maintaining an operation content of the standard desktop.

It is also possible to optimize diverse operation interfaces for an operating system and/or each application in matching with a capability of information terminal apparatus for the remote desktop operations.

What is claimed is:

1. A signal for carrying an interface control program for making a first information processing apparatus let a specific program carry out a processing in response to an operation request from a second information processing apparatus and carry out a processing of transmitting the processed information to the second information processing apparatus when the first information processing apparatus is executing the aforementioned specific program, wherein
the interface control program makes the first information processing apparatus carry out
the first process for obtaining information about an operation screen of the specific program being executed by the first information processing apparatus and recognizing display elements contained by the information; and
the second process for generating screen information on the first information processing apparatus by either the display elements or a combination thereof in response to the operation request from the second information processing apparatus and transmitting the generated screen information thereto.

2. The signal for carrying an interface control program according to claim 1, wherein
the interface control program further makes said first information processing apparatus carry out the third process for notifying said second information processing apparatus of an event which has occurred in the first information processing apparatus corresponding to each of said display elements.

3. The signal for carrying an interface control program according to claim 1, wherein
the interface control program further makes said first information processing apparatus carry out the processing for recognizing said display elements by carrying out at least either one of the processing to recognize
positions of the display elements by a fixed location on said operation screen,
positions of the display elements by calling up an application program interface (API) installed in the first information processing apparatus, or
the display elements based on a display color on the operation screen, in said first process.

4. The signal for carrying an interface control program according to claim 1, wherein
the interface control program further makes said first information processing apparatus carry out the processing of
generating an auxiliary application program in order to operate each of said display elements in said first process, and
controlling a display form of the display elements on said second information processing apparatus by calling up the auxiliary application program therefrom per said operation request in said second process.

5. The signal for carrying an interface control program according to claim 1, wherein
the interface control program further makes said first information processing apparatus carry out the processing of
transmitting menu information containing the lists of said program utilizable by the first information processing apparatus and display elements constituting said operation screen of each of the programs to said second information processing apparatus in said second process.

6. An interface control method for a first information processing apparatus letting a specific program carry out a processing in response to an operation request from a second information processing apparatus and carrying out a process of transmitting the processed information to the second information processing apparatus when the first information processing apparatus is executing the aforementioned specific program, wherein
the first information processing apparatus carries out the first process for obtaining information about an operation screen of the specific program executed by the first information processing apparatus and recognizing display elements contained by the operation screen information; and
the second process for generating screen information on the first information processing apparatus by either the display elements or a combination thereof in response to the operation request from the second information processing apparatus and transmitting the generated screen information thereto.

7. The interface control method according to claim 6, wherein
said first information processing apparatus
carries out a processing of applying said first and second process recursively to an operation screen on each hierarchical layer if said display elements have a hierarchical layer structure.

8. The interface control method according to claim 6, further including
the third process for notifying said second information processing apparatus of an event which has occurred in said first information processing apparatus corresponding to each of said display elements.

9. The interface control method according to claim 6, recognizing said display elements by using at least either of the methods for recognizing
positions of the display elements by a fixed location on said operation screen,
positions of the display elements by calling up an application program interface (API) installed in the first information processing apparatus, or
the display elements based on a display color on the operation screen, in said first process.

10. The interface control method according to claim 6, comprising the processes of
generating an auxiliary application program in order to operate each of said display elements in said first process, and
controlling a display form of the display elements on said second information processing apparatus by calling up the auxiliary application program therefrom per said operation request in said second process.

11. The interface control method according to claim 6, comprising the process of
transmitting menu information containing the lists of said program utilizable by the first information processing apparatus and display elements constituting said operation screen of each of the program to said second information processing apparatus in said second process.

12. The interface control method according to claim 6, wherein
said program is a system program comprising an operating system for controlling said first information processing apparatus, or an application program running on the operating system.

13. An interface control apparatus for making a specific program carry out a processing in response to an operation based on an operation request from a second information processing apparatus when executing the specific program and carrying out a processing of transmitting the processing information to the second information processing apparatus, comprising:
first unit for obtaining information about a operation screen of the specific program and recognizing display elements contained by the information; and
second unit for generating screen information on the first unit by either the display elements or a combination thereof in response to the operation request from the second information processing apparatus and transmitting the generated screen information thereto.

14. A signal for carrying a plug-in program for making a first information processing apparatus carry out a process of adding a function to an application program executed by a first information processing apparatus, wherein
the plug-in program makes the first information processing apparatus carry out the processes of
recognizing display elements of operation screen for the application program;
registering the display elements in a program list in order to select the application program, and
preparing an auxiliary application program interface (aux. API) in order to change a display form of the display elements on a second information processing apparatus which operates the application program remotely.

15. The signal for carrying a plug-in program according to claim 14, wherein
the process for recognizing said display elements recognizing the display elements by using at least either one of the methods for recognizing
positions of the display elements by a fixed location on said operation screen,
positions of the display elements by calling up an application program interface (API) installed in the first information processing apparatus, or
the display elements based on a display color on the operation screen.

16. The signal for carrying a plug-in program according to claim 14, wherein
the plug-in program further makes said first information processing apparatus carry out the processes of
detecting a particular of said display elements which is noted by said second information processing apparatus as an object of operation,
changing a display form of a particular of the display elements which is noted by the second information processing apparatus as an object of operation in response to a request therefrom, and
notifying the second information processing apparatus of an event which has occurred in each of the display elements.

17. An information processing apparatus for carrying out an application program, comprising a control logic comprising:
a first function of recognizing display elements of operation screen of the application program; and a second function of responding to a display request from another information terminal by the display elements or a combination thereof.

18. The information processing apparatus according to claim 17, wherein
said control logic further comprises a third function of notifying said information terminal of an event which has occurred on the information processing apparatus corresponding to each of said display elements.
